(19) United States
(12) Patent Application Publication
(10) Pub. No.: US 2007/0019113 A1
(43) Pub. Date: Jan. 25, 2007

(54) Mixer system with amplitude-, common mode- and phase corrections

(76) Inventors: Jan Van Sinderen, Eindhoven (NL); Marc Godefriedus Marie Notten, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,316

(22) PCT Filed: Nov. 20, 2003
(86) PCT No.: PCT/IB03/05412

§ 371 Date: Jun. 15, 2005

(30) Foreign Application Priority Data
Dec. 19, 2002 (EP) 02080396.1

(51) Int. Cl. H04N 9/68

(52) U.S. Cl. 348/648

(57) ABSTRACT

Mixer-systems (1) comprising mixer-circuits (2) with mixers (3) for frequency translating signals comprising audio/video information and for use in mobile phones or television receivers are provided with amplitude detectors (6) for making amplitude corrections during said frequency translating of said signals comprising audio/video information (basic idea), to correct amplitude errors resulting (insight) from designs with integration technologies based upon small transistors (with small transistors having a size such that phase errors are no longer dominating the performance). Said mixer-circuit (2) comprises amplifier-circuits (3,4) with controllable gains, and said amplitude detectors (6) comprise level detectors (61,62) and amplifiers (63). Further amplitude detectors (7,8,9) make common-mode corrections and comprise either level detectors (71,72,81,82) and amplifiers (73.83) or adders (91) and level detectors (92) and amplifiers (93) and range detectors (94) and inverters (95). Amplifier-circuits (4,5) comprise amplifiers (41,51) with adjustable resistor-elements (42,43,52,53) and with further adjustable resistor-elements 44,45,54,55) for making phase corrections.

The invention relates to a mixer-system comprising a mixer-circuit with at least two mixers for frequency translating signals comprising audio/video information.

The invention also relates to an apparatus comprising at least one polyphase filters and a mixer-system coupled to said polyphase filter, which mixer-system comprises a mixer-circuit with at least two mixers for frequency translating signals comprising audio/video information,

and to a method for frequency translating signals comprising audio/video information via a mixer-circuit with at least two mixers.

Such an apparatus is for example a mobile phone or a television receiver etc., with said (analog and/or digital) signals comprising audio/video information for example being or comprising modulated audio signals of for example a mobile phone call and/or being or comprising modulated video signals of for example a mobile phone camera picture and/or being or comprising modulated audio+video signals of for example a television program and/or being or comprising (modulated) data signals (later) to be represented through audio and/or video etc. Said mixer-circuit frequency translates (downconverts and/or demodulates) signals comprising audio/video information received via for example a mobile phone connection and/or a television cable connection etc. and/or frequency translates (modulates and/or upconverts) signals comprising audio/video information to be transmitted via for example a mobile phone connection etc.

U.S. Pat. No. 6,137,999 discloses a mixer-system comprising a mixer-circuit with at least two mixers e.g. multipliers for frequency translating signals comprising audio/video information in a normal transceiver mode and comprising an amplitude detector for making amplitude corrections for at least one output signal of said mixer-circuit in a calibration mode.

The known system is disadvantageous, inter alia, due to not being able to make corrections (compensations) for irregularities resulting from having designed said mixer-system with integration technologies based upon small transistors i.e. small transistors having a size such that phase errors are no longer dominating the performance.

It is an object of the invention, inter alia, of providing a mixer-system with at least two mixers (multipliers) for frequency translating signals comprising audio/video information, which mixer-system can be designed with integration technologies based upon small transistors.

It is a further object of the invention, inter alia, of providing an apparatus comprising at least one polyphase filter and a mixer-system coupled to said polyphase filter, which mixer-system comprises a mixer-circuit with at least two mixers (multipliers) for frequency translating signals comprising audio/video information, which apparatus can be designed with integration technologies based upon small transistors.

It is a yet further object of the invention, inter alia, of providing a method for frequency translating signals comprising audio/video information via a mixer-circuit with at least two mixers (multipliers), which mixer-system can be designed with integration technologies based upon small transistors.

The mixer-system according to the invention comprises a mixer-circuit with at least two mixers for frequency translating signals comprising audio/video information and comprises an amplitude detector for making amplitude corrections for at least one output signal of said mixer-circuit, wherein said amplitude corrections are made during said frequency translating of said signals comprising audio/video information.

By providing said mixer-system with the amplitude detector for making said amplitude corrections (compensations) during said frequency translating, amplitude errors resulting from designs with integration technologies based upon small transistors are now corrected (compensated).

It should be observed that U.S. Pat. No. 6,137,999 discloses a mixer-system comprising an amplitude detector for making amplitude corrections for at least one output signal of said mixer-circuit in a calibration mode. During this calibration mode, a calibration signal is supplied to the mixers. So, U.S. Pat. No. 6,137,999 does not disclose the making of amplitude corrections during the frequency translating of signals comprising audio/video information in the normal transceiver mode.

U.S. Pat. No. 6,137,999 makes amplitude corrections in a switched way via a switch in a coupling between the output of the amplitude detector and the control input of said mixer-circuit and U.S. Pat. No. 6,137,999 has, in addition to the normal mode, a calibration mode. Therefore, instead of and/or in addition to saying that the mixer-system according to the invention makes amplitude corrections during the frequency translating of the signals comprising audio/video information, one might say that the mixer-system according to the invention makes amplitude corrections switchlessly and/or calibrationlessly, and/or that said coupling is switchless.

A first embodiment of the mixer-system according to the invention is defined by claim 2.

By providing said amplitude detector with at least two inputs coupled to at least two outputs of said mixer-circuit and with at least one output coupled to at least one control input of said mixer-circuit and by providing said mixer-circuit with at least two amplifier-circuits coupled to said mixers (multipliers) for amplifying mixer signals, with at least one of said amplifier-circuits being coupled to said control input for receiving a control signal for controlling a gain of said amplifier-circuit, a low cost and low complex implementation has been created for making said amplitude corrections for at least one output signal of said mixer-circuit.

A second embodiment of the mixer-system according to the invention is defined by claim 3.

By providing said amplitude detector with at least two level detectors each comprising an output coupled to an input of an amplifier, a low cost and low complex implementation has been created for said amplitude detector. Said level detectors for example each comprise a rectifier like a diode or a transistor etc. together with a smoothing element like a capacitor etc. for smoothing rectified signals.

A third embodiment of the mixer-system according to the invention is defined by claim 4.

By providing said mixer-system with at least one further amplitude detector per amplifier-circuit for controlling a gain of said amplifier-circuit, common-mode corrections (compensations) can be made.

A fourth embodiment of the mixer-system according to the invention is defined by claim 5.

By providing said further amplitude detector with at least two level detectors with (balanced) inputs of said level detectors being coupled to (balanced) outputs of said amplifier-circuit and with outputs of said level detectors being coupled to inputs of an amplifier, a low cost and low complex implementation has been created for said further amplitude detector.

A fifth embodiment of the mixer-system according to the invention is defined by claim 6.

By providing said further amplitude detector with at least one adder for adding (balanced) output signals of said amplifier-circuit, which adder comprises an output coupled to an input of a level detector comprising an output coupled to an input of an amplifier, which amplifier comprises an output coupled to an input of a range detector and to an input of an inverter controlled by said range detector, a low cost and low complex implementation has been created for said further amplitude detector.

When comparing the fourth and fifth embodiment, the fourth embodiment will be even more low cost and even more low complex, with said fifth embodiment being more accurate.

A sixth embodiment of the mixer-system according to the invention is defined by claim 7.

By providing said amplifier-circuits each with an amplifier with at least a first input and a first output coupled to each other via a first resistor-element and with at least a second input and a second output coupled to each other via a second resistor-element, with at least one resistor-element in at least one of said amplifier-circuits being adjustable for controlling the gain of said amplifier-circuit, a low cost and low complex implementation has been created for said amplifier-circuit. Said (adjustable) resistor-elements for example comprise (adjustable) resistors and/or (controllable) transistors and/or combinations of resistors and transistors (with a transistor for example short-circuiting or not one of two serial transistors or coupling or not one resistor in parallel to another resistor) etc.

A seventh embodiment of the mixer-system according to the invention is defined by claim 8.

By coupling at least one output of one of said amplifier-circuits to at least one input of the other amplifier-circuit via at least one further adjustable resistor-element, phase corrections (compensations) can be made.

Embodiments of the apparatus according to the invention and of the method according to the invention correspond with the embodiments of the system according to the invention.

The invention is based upon an insight, inter alia, that in mixer-systems designed with integration technologies based upon small transistors i.e. transistors having a size such that phase errors are no longer dominating the performance, these small transistors have, compared to larger transistors i.e. transistors having a size such that phase errors are dominating the performance, smaller parasitic capacitors, which reduce the frequency dependencies and larger absolute spreads at on-resistance, which reduce the image suppression at low frequencies resulting in amplitude errors, and is based upon a basic idea, inter alia, that these amplitude errors should be corrected (compensated).

The invention solves the problem, inter alia, of providing a mixer-system which can be designed with integration technologies based upon small transistors, and is advantageous, inter alia, in that amplitude corrections are made switchlessly and/or calibrationlessly, with small transistors of course reducing the power consumption.

It should be further observed that U.S. Pat. No. 6,137,999 does not disclose said insight; on the contrary, U.S. Pat. No. 6,137,999 needs a calibration mode to deal with temperature and voltage changes and for trying to eliminate some filters.

These and other aspects of the invention will be apparent from and elucidated with reference to the embodiments(s) described hereinafter.

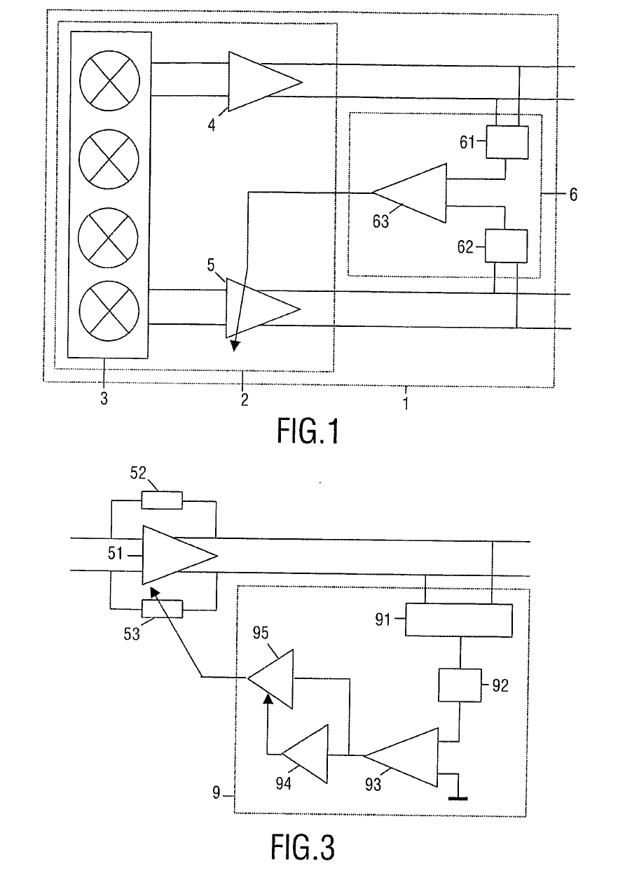

FIG. 1 illustrates in block diagram form a mixer-system according to the invention comprising a mixer-circuit with mixers and amplifier-circuits and comprising an amplitude detector,

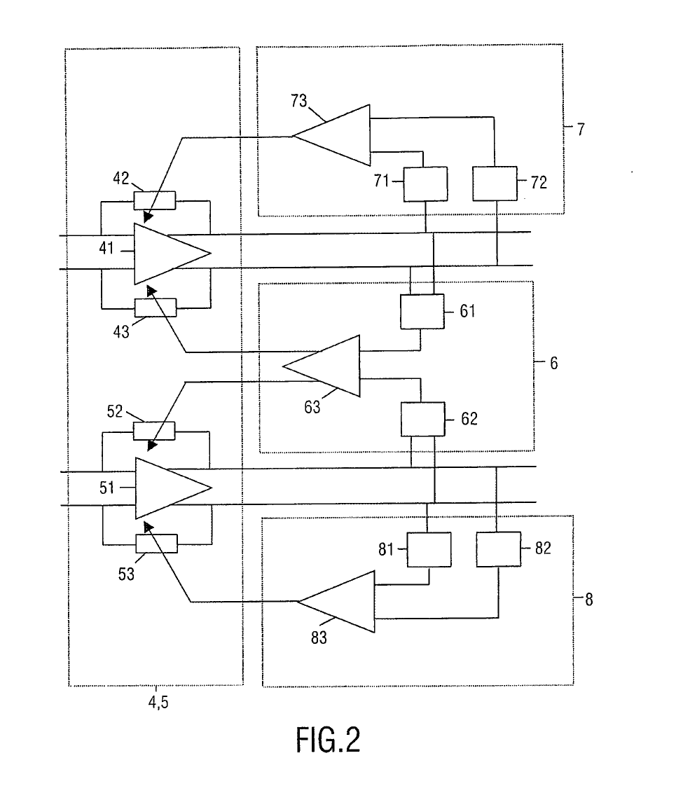

FIG. 2 illustrates in block diagram form two amplifier-circuits and an amplitude detector and two further amplitude detectors for first common-mode corrections for use in a mixer-system according to the invention,

FIG. 3 illustrates in block diagram form a further amplitude detector for a second common-mode correction for use in a mixer-system according to the invention, and

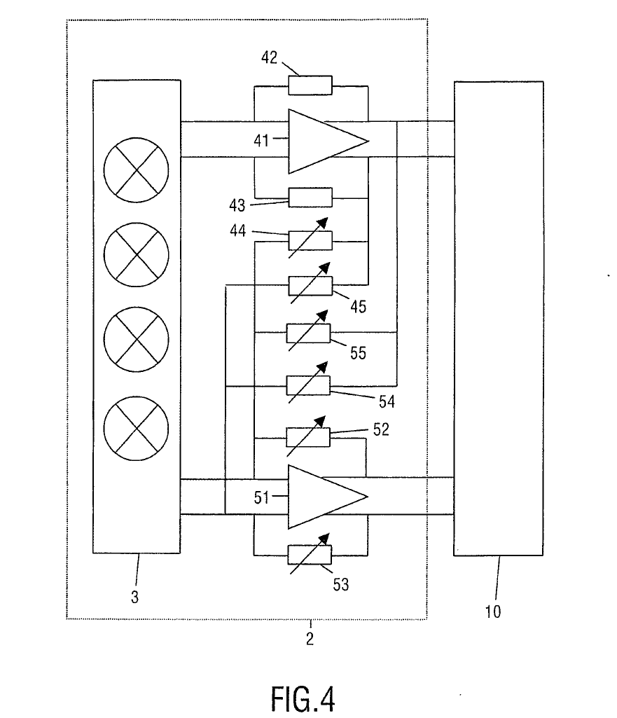

FIG. 4 illustrates in block diagram form a mixer-circuit comprising mixers and amplifiers with adjustable resistor-elements for making amplitude corrections and with further adjustable resistor-elements for making phase corrections for use in a mixer-system according to the invention.

The mixer-system 1 according to the invention shown in FIG. 1 for use in an apparatus like for example a mobile phone or a television receiver etc. comprises a mixer-circuit 2 comprising a mixer-block 3 with for example two or four etc. mixers (multipliers) and with for example two amplitude-circuits 4,5. In the balanced situation, two inputs of each amplifier-circuit 4,5 are coupled to two outputs of said mixer-block 3. Mixer-system 1 further comprises an amplitude detector 6 comprising two level detectors 61,62 of which the outputs are coupled to inputs of an amplifier 63. An output of amplifier 63 forms the output of amplitude detector 6 and is coupled to a control input of mixer-circuit 2 for controlling the gain of for example amplifier-circuit 5. In the balanced situation, two inputs of level detector 61 are coupled to the outputs of amplifier-circuit 4, and two inputs of level detector 62 are coupled to the outputs of amplifier-circuit 5. Then, these four inputs of level detectors 61,62 form the inputs of amplitude detector 6.

Mixer-system 1 shown in FIG. 1 comprises mixer-circuit 2 with mixer block 3 for frequency translating signals comprising audio/video information. These analog and/or digital signals comprising audio/video information for example correspond with or comprise analog and/or digital modulated audio signals of for example a mobile phone call and/or correspond with or comprise analog and/or digital modulated video signals of for example a mobile phone camera picture and/or correspond with or comprise analog and/or digital modulated audio+video signals of for example a television program and/or correspond with or comprise (analog and/or digital) (modulated) data signals (later) to be represented through audio and/or video etc. and are for example supplied to said mixer block 3 either via one or more polyphase filters (in case of mixer-block 3 comprising for example four mixers (multipliers) etc.) for converting the signals comprising audio/video information into complex signals (like for example I and Q signals) and for filtering certain harmonics, or not (in case of mixer-block 3 comprising for example two mixers (multipliers) etc.). Said mixer block 3 frequency translates (downconverts and/or demodulates) signals comprising audio/video information received via for example a mobile phone connection and/or a television cable connection etc. and/or frequency translates (modulates and/or upconverts) signals comprising audio/video information to be transmitted via for example a mobile phone connection etc. The output signals of mixer-circuit 2 are for example supplied to one or more further polyphase filters for filtering and deconverting said output signals. In case of mixer block 3 making downconversions, the signals comprising audio/video information to be supplied to said polyphase filters are for example RF (radio frequency) signals, the signals supplied to mixer block 3 are for example RF-I and RF-Q signals, the signals coming from mixer-block 3 are for example IF-I and IF-Q signals, and the output signals generated by said further polyphase filters are for example IF (intermediate frequency) signals.

Mixer-system 1 is provided with amplitude detector 6 for correcting (compensating) amplitude errors resulting from designs with integration technologies based upon small transistors. Contrary to prior art, amplitude detector 6 corrects (compensates) amplitude errors during said frequency translating of said signals comprising audio/video information.

Each mixer or multiplier frequency translates an input signal through mixing or multiplying said input signal with a local oscilator signal. This results in a wanted signal and an unwanted image signal. To suppress said unwanted image signal, two mixers or multipliers are used each receiving said input signal which two mixers or multipliers are followed by one or more polyphase filters. This combination of two mixers or multipliers is often called a complex mixer. To obtain higher suppression, a full complex mixer can be used, comprising two complex mixers receiving phase shifted input signals and for example originate from one or more polyphase filters.

A mixer or multiplier can for example be designed by using MOS transistors: in a balanced situation, one input is coupled to fist main electrodes of a first and second MOS transistor, the other input is coupled to first main electrodes of a third and fourth MOS transistor, second main electrodes of said first and fourth MOS transistor are coupled to each other and form a first output, and second main electrodes of said second and third MOS transistor are coupled to each other and form a first output. Control electrodes of said first and third MOS transistor are coupled to each other and form a first oscillator input, and control electrodes of said second and fourth MOS transistor are coupled to each other and form a second oscillator input. Alternatively, a mixer or multiplier can be designed by using bipolar transistors similarly etc.

Said level detectors for example each comprise a rectifier like a diode or a transistor etc. together with a smoothing element like a capacitor etc. for smoothing rectified signals.

The part of the mixer-system 1 according to the invention shown in FIG. 2 comprises two amplifier-circuits 4,5 and an amplitude detector 6 and two further amplitude detectors 7,8 for first common-mode corrections. Amplifier-circuit 4 comprises an amplifier 41 and amplifier-circuit 5 comprises an amplifier 51. In the balanced situation, amplifier 41 has two inputs coupled to outputs of mixer block 3 and two outputs coupled to inputs of level detector 61 in amplitude detector 6 and to inputs of further amplitude detector 7, and amplifier 51 has two inputs coupled to outputs of mixer block 3 and two outputs coupled to inputs of level detector 62 in amplitude detector 6 and to inputs of further amplitude detector

Of amplifier 41, a first input and a first output are coupled to each other via a first resistor-element 42 and a second input and a second output are coupled to each other via a second resistor-element 43. Of amplifier 51, a first input and a first output are coupled to each other via a first resistor-element 52 and a second input and a second output are coupled to each other via a second resistor-element 53. Resistor-elements 43 and 52 are adjustable and controlled by output signals originating from an amplifier 63 of amplitude detector 6, with outputs of level detectors 61 and 62 being coupled to inputs of amplifier 63. Resistor-element 42 is adjustable and controlled by an output signal originating from an amplifier 73 of further amplitude detector 7, with outputs of level detectors 71 and 72 being coupled to inputs of amplifier 73, and with inputs of level detectors 71 and 72 forming the inputs of further amplitude detector 7. Resistor-element 53 is adjustable and controlled by an output signal originating from an amplifier 83 of further amplitude detector 8, with outputs of level detectors 81 and 82 being coupled to inputs of amplifier 83, and with inputs of level detectors 81 and 82 forming the inputs of further amplitude detector 8.

Said amplitude detector 6 corrects (compensates) said amplitude errors as described before. Said further amplitude detectors 7,8 correct (compensate) common-mode errors in a first way. These common-mode errors may result from designs with integration technologies based upon small transistors, or not. Due to polyphase filters not rejecting common-modes, further amplitude detectors 7,8 improve the mixer-system 1 advantageously.

Further amplitude detector 9 shown in FIG. 3 corrects common-mode errors in a second way which is more accurate than said first way due to being based upon an adder 91 which can be made very accurately. Further amplitude detector 9 may replace said further amplitude detectors 7,8 and comprises said adder 91 of which the inputs form the inputs of further amplitude detector 9 and are coupled to the outputs of amplifier 51 (or 41) for adding the balanced output signals of said amplifier 51 (or 41). An output of adder 91 is coupled to an input of a level detector 92, of which an output is coupled to a first input of an amplifier 93. A second input of amplifier 93 is coupled to ground, and an output of amplifier 93 is coupled to an input of a range detector 94 and to an input of an inverter 95, with range detector 94 controlling said inverter 95. This range detector 94 is for example a window detector and/or an hystere detector and is necessary for guiding the controlling of resistor-element 53 (or 42) into the right direction: adder 91 generates an absolute error, without indicating a sign of said error.

Mixer-circuit 2 shown in FIG. 4 comprises mixer block 3 and amplifiers 41,51 with resistor-elements 42,43 and with adjustable resistor-element 52 for making amplitude corrections and with adjustable resistor-element 53 for making common-mode corrections as shown in and discussed at the hand of FIG. 2 whereby for clarity purposes said amplitude detectors 6,7,8,9 have not been shown. Outputs of amplifiers 41,51 are further coupled to inputs of one or more polyphase filters 10. Further adjustable resistor-elements 44,45,54,55 have been added for making phase corrections. One side of further adjustable resistor-elements 44,45 is coupled to the second output of amplifier 41, the other side of further adjustable resistor-element 44 is coupled to the first input of amplifier 51 and the other side of further adjustable resistor-element 45 is coupled to the second input of amplifier 51. One side of further adjustable resistor-elements 54,55 is coupled to the first output of amplifier 41, the other side of further adjustable resistor-element 54 is coupled to the second input of amplifier 51 and the other side of further adjustable resistor-element 55 is coupled to the first input of amplifier 51.

To control resistor-elements 44,45,54,55, a mixer or multiplier can be used to detect the phase error between the I and Q signal. After filtering, the resulting error signal can be used to control the resistors 44,45,54,55. If the angle is larger than 90 degrees, resistor-elements 45 and 55 are used to add some I (or Q) signal to the Q (or I) signal. If the angle is smaller than 90 degrees, resistor-elements 44 and 54 are used to substract some I (or Q) signal from the Q (or I) signal.

Said (adjustable) resistor-elements for example comprise (adjustable) resistors and/or (controllable) transistors and/or combinations of resistors and transistors (with a transistor for example short-circuiting or not one of two serial transistors or coupling or not one resistor in parallel to another resistor) etc.

The expression “for” in for example “for frequency translating” and “for making corrections” and “for receiving” and “for amplifying” etc. does not exclude that other functions are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprises/included as well. The terms “a” and “an” do not exclude the possible presence of one or more pluralities. The term “said amplitude corrections are made during said frequency translating of said signals etc.” corresponds with “one or more amplitude corrections are made while frequency translating one or more signals etc.”.

The invention is based upon an insight, inter alia, that in mixer-systems designed with integration technologies based upon small transistors (with small transistors having a size such that phase errors are no longer dominating the performance), these small transistors have, compared to larger transistors (with larger transistors having a size such that phase errors are dominating the performance), smaller parasitic capacitors (which reduce the frequency dependencies) and larger absolute spreads at on-resistance (which reduce the image suppression at low frequencies) resulting in amplitude errors, and is based upon a basic idea, inter alia, that these amplitude errors should be corrected (compensated).

The invention solves the problem, inter alia, of providing a mixer-system which can be designed with integration technologies based upon small transistors, and is advantageous, inter alia, in that amplitude corrections are made switchlessly and/or calibrationlessly, with small transistors of course reducing the power consumption.

1. Mixer-system comprising a mixer-circuit with at least two mixers for frequency translating signals comprising audio/video information and comprising an amplitude detector for making amplitude corrections for at least one output signal of said mixer-circuit, wherein said amplitude corrections are made during said frequency translating of said signals comprising audio/video information.

2. Mixer-system according to claim 1, wherein said amplitude detector comprises at least two inputs coupled to at least two outputs of said mixer-circuit and at least one output coupled to at least one control input of said mixer-circuit, with said mixer-circuit further comprising at least two amplifier-circuits coupled to said mixers for amplifying mixer signals, with at least one of said amplifier-circuits being coupled to said control input for receiving a control signal for controlling a gain of said amplifier-circuit.

3. Mixer-system according to claim 2, wherein said amplitude detector comprises at least two level detectors each comprising an output coupled to an input of an amplifier.

4. Mixer-system according to claim 2, wherein said mixer-system comprises at least one further amplitude detector per amplifier-circuit of which further amplitude detector at least one input is coupled to at least one output of said amplifier-circuit and of which further amplitude detector at least one output is coupled to said amplifier-circuit for controlling a gain of said amplifier-circuit for making common-mode corrections.

5. Mixer-system according to claim 4, wherein said farther amplitude detector comprises at least two level detectors with inputs of said level detectors being coupled to outputs of said amplifier-circuit and with outputs of said level detectors being coupled to inputs of an amplifier.

6. Mixer-system according to claim 4, wherein said further amplitude detector comprises at least one adder for adding output signals of said amplifier-circuit, which adder comprises an output coupled to an input of a level detector comprising an output coupled to an input of an amplifier, which amplifier comprises an output coupled to an input of a range detector and to an input of an inverter controlled by said range detector.

7. Mixer-system according to claim 2, wherein said amplifier-circuits each comprise an amplifier with at least a first input and a first output coupled to each other via a first resistor-element and with at least a second input and a second output coupled to each other via a second resistor-element, with at least one resistor-element in at least one of said amplifier-circuits being adjustable for controlling the gain of said amplifier-circuit.

8. Mixer-system according to claim 7, wherein at least one output of one of said amplifier-circuits is coupled to at least one input of the other amplifier-circuit via at least one further resistor-element which is adjustable for making phase corrections.

9. Apparatus comprising at least one polyphase filters and a mixer-system coupled to said polyphase filter, which mixer-system comprises a mixer-circuit with at least two mixers for frequency translating signals comprising audio/video information and comprising an amplitude detector for making amplitude corrections for at least one output signal of said mixer-circuit, wherein said amplitude corrections are made during said frequency translating of said signals comprising audio/video information.

10. Method for frequency translating signals comprising audio/video information via a mixer-circuit with at least two mixers and comprising the step of making amplitude corrections for at least one output signal of said mixer-circuit via an amplitude detector, wherein said step of making amplitude corrections is performed during said frequency translating of said signals comprising audio/video information.
